(19) United States
(12) Patent Application Publication
(10) Pub. No.: US 2013/0081521 A1
(43) Pub. Date: Apr. 4, 2013

(54) CLOSE FITTING STRUCTURE OF SLEEVE TOOL

(71) Applicant: Shyh Ming Wang, Taichung City (TW)

(72) Inventor: Shyh Ming Wang, Taichung City (TW)

(21) Appl. No.: 13/249,275

(22) Filed: Sep. 30, 2011

(51) Int. Cl. B25B 13/06

(52) U.S. Cl. 81/121.1

(57) ABSTRACT

A close fitting structure of a sleeve tool is provided. A through-hole is formed to penetrate a sidewall of the sleeve tool. The close fitting structure includes a body. Sharp engaging teeth are disposed at a front end of the body. The close fitting structure is received in the through-hole of the sleeve tool and adapted to move forward and backward spirally. The close fitting structure is inserted deep into the sleeve tool, such that the sharp engaging teeth disposed at the front end of the body and a nut mesh in a close-fitting manner. Accordingly, the close fitting structure enables the sleeve tool and the nut to mesh efficiently and to be loosened and tightened easily and in a slide-free manner.

### BACKGROUND OF THE INVENTION

1. Field of the Invention

The present invention relates to sleeve tools, and more particularly, to a close fitting structure of a sleeve tool for loosening and tightening a nut with worn edges and corners.

2. Description of the Related Art

The operation of loosening and tightening a nut can be carried out with a sleeve tool, such as a sleeve wrench. However, nuts are often subjected to rusting, undue forces, or improper operation, and in consequence edges and corners of the nuts wear out or are even rounded off; as a result, the nuts become too slippery to be manipulated with the sleeve tool and thus cannot be loosened or tightened. The aforesaid drawback of the prior art annoys users. Hence, it is imperative to overcome the aforesaid drawback of the prior art.

U.S. Pat. No. 6,923,096 provides an adjustable socket wrench for loosening and tightening nuts of different dimensions and specifications. The adjustable socket wrench has a non-equilateral socket cavity of large dimensions. A hole is laterally formed in the socket body and can be coupled to a drive bar. Hence, the socket wrench can be fitted closely to a nut to be loosened or tightened. Furthermore, the drive bar abuts against the nut, such that the nut is engaged with the non-equilateral socket cavity of large dimensions in a close-fitting manner, thereby achieving the purpose of loosening and tightening nuts of different dimensions and specifications.

However, practical experience and analysis reveal that the conventional sleeve has the following drawbacks:

A. The sleeve body is of large dimensions with a view to loosening and tightening nuts of different dimensions and specifications; as a result, the sleeve is too big or user-unfriendly to loosen or tighten small nuts.

B. The sleeve has a non-equilateral socket cavity of large dimensions. The sides of the socket cavity are of different levels of strength and thus are unable to bear the strong torque that accompanies the loosening or tightening of a nut; as a result, not only is the socket cavity likely to be damaged, but edges and corners of the nut are likely to be damaged to the extent that the nut tends to slip while being loosened or tightened.

C. The sleeve proves ineffective in engaging with a rusty nut or a nut with worn edges and corners in a close-fitting manner and thus is unable to loosen or tighten the nut. Furthermore, loosening, tightening, or pulling a screw with a rusty nut or a nut with worn edges and corners poses a challenge.

### SUMMARY OF THE INVENTION

It is an objective of the present invention to provide a means of loosening and tightening a rusty nut or a slippery nut with worn edges and corners. To this end, the present invention provides a close fitting structure of a sleeve tool. A through-hole is formed to penetrate a sidewall of the sleeve tool. The close fitting structure comprises a body. Sharp engaging teeth are disposed at the front end of the body. The close fitting structure is received in the through-hole of the sleeve tool and is capable of moving forward and backward spirally. The close fitting structure is inserted deep into the sleeve tool, such that the sharp engaging teeth disposed at the front end of the body and a nut mesh in a close-fitting manner. Hence, the sleeve tool and the nut can mesh efficiently and can be loosened and tightened easily and in a slide-free manner.

An open receiving space is disposed at the front section of the body of the close fitting structure to receive a resilient close fitting element. The resilient close fitting element abuts against the nut in a close-fitting manner, such that the sleeve tool and the nut can mesh efficiently and can be loosened and tightened easily, and eventually the nut has a fat chance of escaping.

The present invention further provides a close fitting structure of a sleeve tool. A through-hole is formed to penetrate a sidewall of the sleeve tool. The close fitting structure comprises a body. Sharp engaging teeth are disposed at the front end of the body. A dam is circumferentially disposed at the middle section of the body. Resilient bodies are series-connected to the front end and the rear end of the dam, respectively. A close fitting screw ring is disposed around the rear end of the body and screwed to the outer section of the through-hole of the sleeve tool. The body is inserted into the through-hole of the sleeve tool in a manner that the rear end of the body is inserted into the close fitting screw ring and the front end of the body protrudes out of the through-hole, such that the resilient bodies abut against the inner side of the through-hole and the close fitting screw ring and are disposed therebetween. As a result, the close fitting structure is inserted deep into the sleeve tool, and the close fitting screw ring can be continuously screwed inward to press against the body, such that the front sharp engaging teeth disposed at the front end of the body and the nut mesh in a close-fitting manner. Hence, the close fitting structure enables the sleeve tool and the nut to mesh efficiently and to be loosened and tightened easily and in a slide-free manner. Accordingly, the present invention is effective in solving a drawback of the prior art—the difficulty in loosening and tightening a rusty nut or a nut with worn edges and corners.

BRIEF DESCRIPTION OF THE SEVERAL VIEWS OF THE DRAWINGS

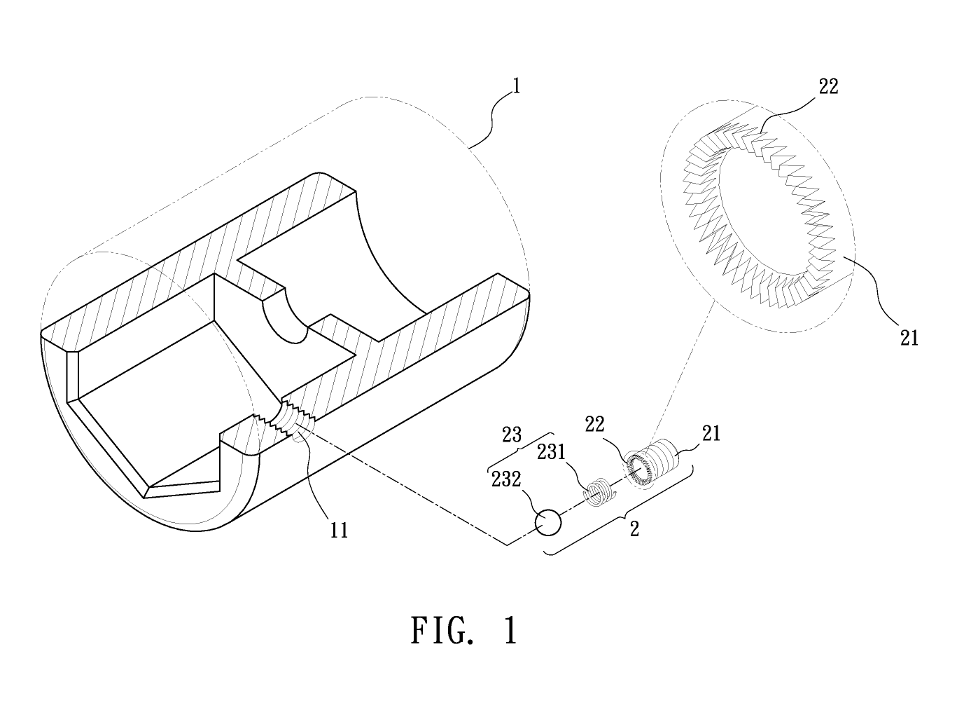

FIG. 1 is a schematic view of the structure of a preferred embodiment of the present invention;

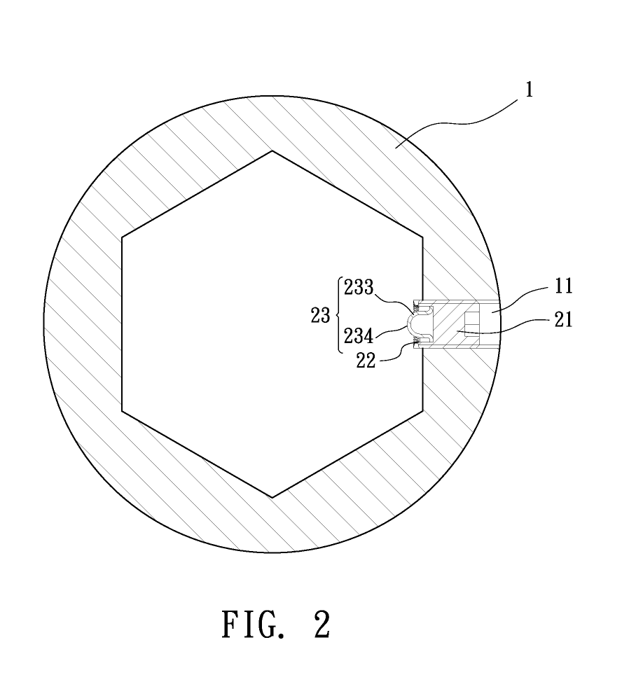

FIG. 2 is a schematic view of another feasible way of implementing a resilient close fitting element of the present invention;

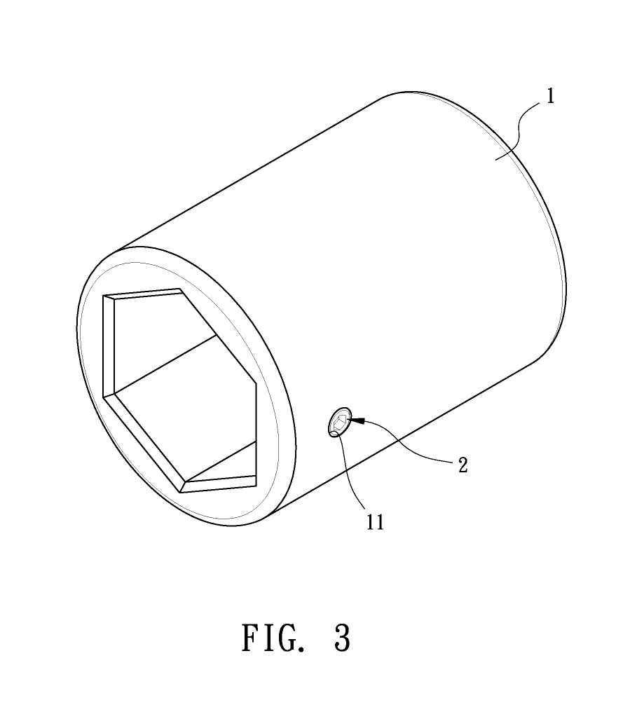

FIG. 3 is an assembled perspective view of the structure of the preferred embodiment of the present invention;

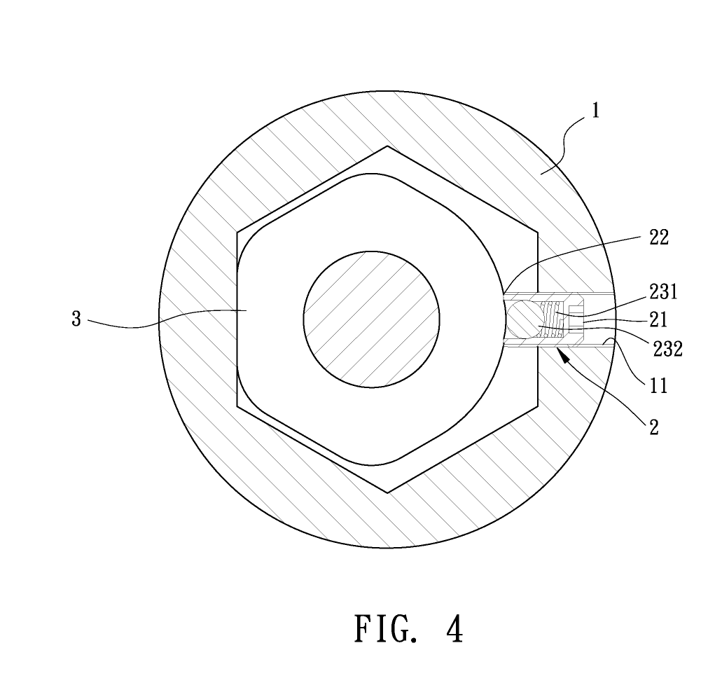

FIG. 4 is a schematic view of the application of the preferred embodiment of the present invention;

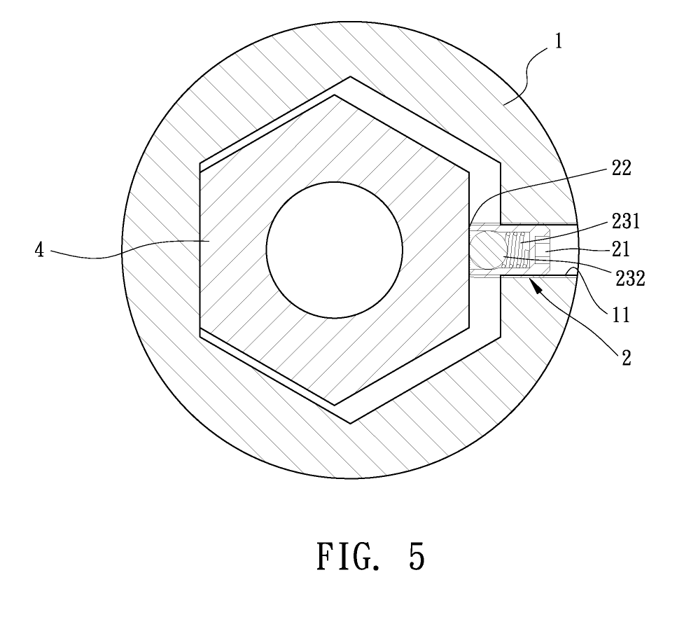

FIG. 5 is another schematic view of the application of the preferred embodiment of the present invention;

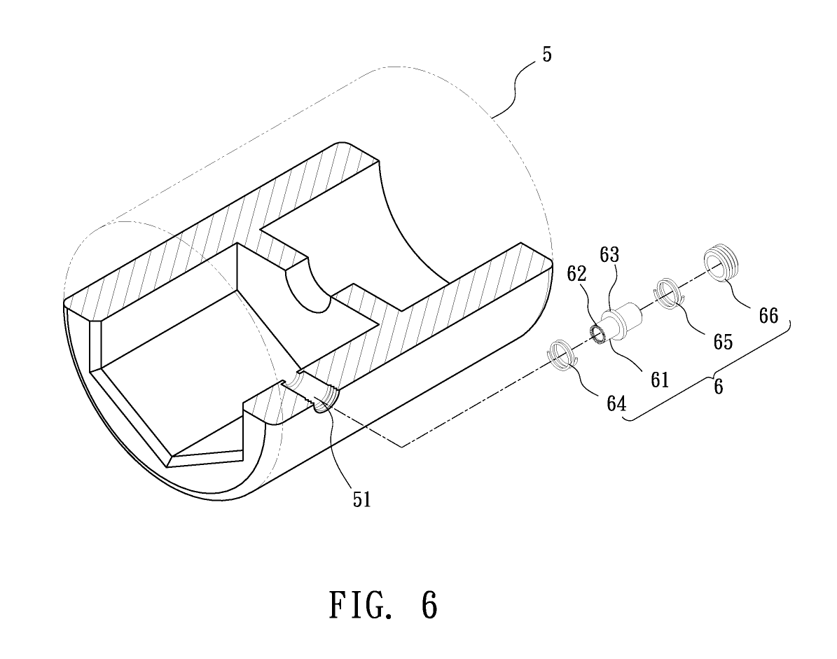

FIG. 6 is a schematic view of the structure of another embodiment of the present invention;

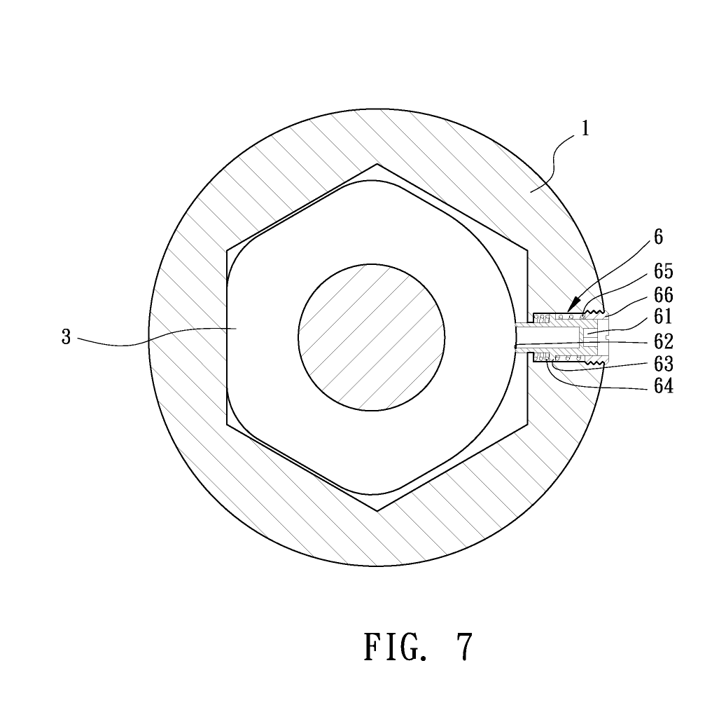

FIG. 7 is a schematic view of the application of another embodiment of the present invention; and

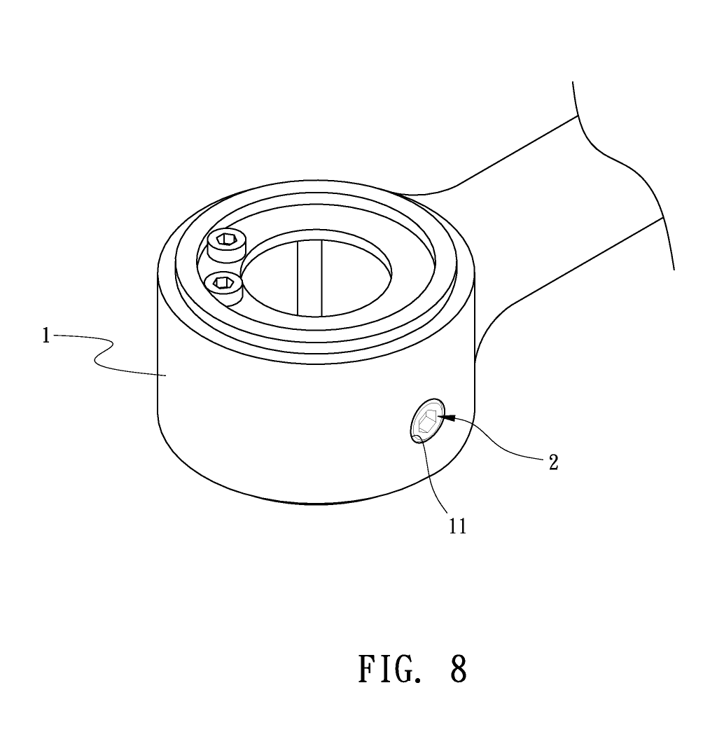

FIG. 8 is a schematic view of a sleeve tool implemented in the form of a ratchet-type screw puller according to the present invention.

### DETAILED DESCRIPTION OF THE EMBODIMENTS OF THE INVENTION

Referring to FIG. 1, in a preferred embodiment of the present invention, a close fitting structure 2 of a sleeve tool 1 is provided. A through-hole 11 is formed to penetrate a sidewall of the sleeve tool 1. A thread is disposed on a wall surface of the through-hole 11.

The close fitting structure 2 comprises a body 21. The body 21 is made of a material of high rigidity. Sharp engaging teeth 22 are disposed at the front end of the body 21. A thread is disposed on the surface of the body 21. An open receiving space is disposed at the front section of the body 21 to receive a resilient close fitting element 23.

The resilient close fitting element 23 comprises a resilient body 231 and a close-fitting body 232. The close-fitting body 232 is resiliently pushed by the resilient body 231 to protrude from an open outlet at the front end of the body 21. The resilient body 231 is a spring. The close-fitting body 232 is ball-shaped.

In a variant embodiment of the present invention, the resilient close fitting element 23 is a leaf spring 233 with a protruding portion 234 that protrudes from the open outlet at the front end of the body 21, as shown in FIG. 2.

The close fitting structure 2 is received in the through-hole 11 of the sleeve tool 1 and is capable of moving forward and backward spirally.

Referring to FIG. 3, there is shown an assembled perspective view of the structure of the preferred embodiment of the present invention. As shown in FIG. 3, the present invention effectuates nut loosening and tightening and is, in particular, applicable to a nut with worn edges and corners. As shown in FIG. 4, the preferred embodiment of the present invention is exemplified by a sleeve wrench whereby the close fitting structure 2 is inserted deep into the sleeve tool 1, such that the sharp engaging teeth 22 disposed at the front end of the body 21 and a nut 3 mesh in a close-fitting manner. Hence, the close fitting structure 2 enables the sleeve tool 1 and the nut 3 to mesh efficiently and to be loosened and tightened easily and in a slide-free manner.

Referring to FIG. 5, to loosen or tighten a nut 4 of a relatively small size when a sleeve tool of appropriate specifications is unavailable, it is feasible to insert the close fitting structure 2 deep into the sleeve tool 1 in a manner that the resilient close fitting element 23 abuts against the nut 4 in a close-fitting manner, thereby causing the sleeve tool 1 and the nut 4 to mesh efficiently and to be loosened and tightened easily.

In the preferred embodiment of the present invention, it is also feasible for the resilient close fitting element 23 to abut against a nut, such that the nut cannot escape while in use.

Referring to FIG. 6, in another embodiment of the present invention, a close fitting structure 6 of a sleeve tool 5 is provided. A through-hole 51 is formed to penetrate a sidewall of the sleeve tool 5. The close fitting structure 6 comprises a body 61. The body 61 is made of a material of high rigidity. Sharp engaging teeth 62 are disposed at the front end of the body 61.

A dam 63 is circumferentially disposed at the middle section of the body 61. Resilient bodies 64, 65 are series-connected to the front end and the rear end of the dam 63, respectively. The resilient bodies 64, 65 are springs.

A close fitting screw ring 66 is disposed around the rear end of the body 61 and screwed to the outer section of the through-hole 51 of the sleeve tool 5.

The body 61 is inserted into the through-hole 51 of the sleeve tool 5 in a manner that the rear end of the body 61 is inserted into the close fitting screw ring 66 and the front end of the body 61 protrudes out of the through-hole 51, such that the resilient bodies 64, 65 abut against the inner side of the through-hole 51 and the close fitting screw ring 66 and are disposed therebetween.

Accordingly, the present invention effectuates nut loosening and tightening and is, in particular, applicable to a nut with worn edges and corners. As shown in FIG. 7, the close fitting structure 6 is inserted deep into the sleeve tool 5, and the close fitting screw ring 66 can be continuously screwed inward to press against the body 61, such that the front sharp engaging teeth 62 disposed at the front end of the body 61 and the nut 3 mesh in a close-fitting manner. Hence, the close fitting structure 6 enables the sleeve tool 5 and the nut 3 to mesh efficiently and to be loosened and tightened easily and in a slide-free manner.

If the nut is severely damaged, it will be feasible to hit the rear end of the body 61 directly to ensure that the front end of the front sharp engaging teeth 62 and the nut 3 can mesh in a close-fitting manner, such that the sleeve tool 5 and the nut 3 can mesh efficiently and in a close-fitting manner and can be loosened and tightened easily and in a slide-free manner.

Referring to FIG. 8, the sleeve tool 1 is not only implemented in the form of a sleeve wrench but can also be implemented in the form of a ratchet-type screw puller for pulling a screw.

What is claimed is:

1. A close fitting structure of a sleeve tool, wherein a through-hole is formed to penetrate a sidewall of the sleeve tool, the close fitting structure comprising:
a body having sharp engaging teeth disposed at a front end of the body,
wherein the close fitting structure is received in the through-hole of the sleeve tool.

2. The close fitting structure of claim 1, wherein a thread is disposed on a wall surface of the through-hole of the sleeve tool, and another thread is disposed on a surface of the body of the close fitting structure, such that the close fitting structure is received in the through-hole of the sleeve tool and adapted to move forward and backward spirally.

3. The close fitting structure of claim 1, wherein an open receiving space is disposed at a front section of the body to receive a resilient close fitting element.

4. The close fitting structure of claim 3, wherein the resilient close fitting element comprises a resilient body and a close-fitting body, the close-fitting body being resiliently pushed by the resilient body to protrude from an open outlet at the front end of the body.

5. The close fitting structure of claim 3, wherein the resilient close fitting element is a leaf spring with a protruding portion protruding from an open outlet at the front end of the body.

6. A close fitting structure of a sleeve tool, wherein a through-hole is formed to penetrate a sidewall of the sleeve tool, the close fitting structure comprising:
a body having sharp engaging teeth disposed at a front end of the body, wherein a dam is circumferentially disposed at a middle section of the body, and resilient bodies are series-connected to a front end and a rear end of the dam, respectively; and
a close fitting screw ring disposed around a rear end of the body and screwed to an outer section of the through-hole of the sleeve tool,
wherein the body is inserted into the through-hole of the sleeve tool in a manner that the rear end of the body is inserted into the close fitting screw ring and the front end of the body protrudes out of the through-hole such that the resilient bodies abut against an inner side of the through-hole and the close fitting screw ring and are disposed therebetween.
